(19) United States
(12) Patent Application Publication
(10) Pub. No.: US 2018/0109915 A1
(43) Pub. Date: Apr. 19, 2018

(54) SYSTEMS, METHODS AND DEVICES FOR VIRTUAL FENCING

(71) Applicant: Alibaba Group Holding Limited, George Town (KY)

(72) Inventors: Maocai Shao, Beijing (CN); Weixiang Zhang, Beijing (CN); Xin Liu, Beijing (CN); Xinghao Wu, Beijing (CN); Yuxing Fang, Beijing (CN); Xiaobo Geng, Beijing (CN); Peiyang Zhang, Hangzhou (CN); Xun Wang, Hangzhou (CN); Jinfeng Liu, Shanghai (CN)

(21) Appl. No.: 15/728,327

(22) Filed: Oct. 9, 2017

(30) Foreign Application Priority Data
Oct. 13, 2016 (CN) 201610895406.X

(51) Int. Cl. H04W 4/02; H04W 4/14; H04L 29/08

(52) U.S. Cl. CPC H04W 4/021; H04W 4/028; H04L 67/303; H04L 67/18; H04W 4/14

(57) ABSTRACT

A method for virtual fencing including: obtaining first user status information pertaining to user location, user behavior, or both; generating a first notification upon detecting that the first user status information meets a triggering condition of a virtual fence, wherein the triggering condition comprises point of interest information, area of interest information, or both; and sending the first notification.

### CROSS REFERENCE TO OTHER APPLICATIONS

This application claims priority to People's Republic of China Patent Application No. 201610895406.X entitled A VIRTUAL FENCE-BASED INFORMATION-PROCESSING METHOD, CLIENT AND SERVER, filed Oct. 13, 2016 which is incorporated herein by reference for all purposes.

### FIELD OF THE INVENTION

The present application relates generally to the field of data processing and more particularly, to data processing systems, methods and devices using virtual fences.

### BACKGROUND OF THE INVENTION

As the electronic communications technology develops, various types of mobile devices, e.g., mobile phones, smart phones, tablet computers, notebook computers, laptop computers, wearable personal devices, portable media devices, in-vehicle device, or the like, have become popular with the general public. Moreover, the functionalities and features provided by the various mobile devices have also become increasingly more powerful in the sense that they provide the users with a multitude of ease to use services. One of these mobile services is location-based services (LBS), which identifies the location information (e.g., geographical coordinates or geodetic coordinates) of a mobile device of a user, through telecommunication networks (e.g., GSM or CDMA networks) operated by telecommunication service providers, or external location-determination techniques (e.g., the global positioning system (GPS)), to provide pertinent services with support of platforms such as a geographic information system (GIS) to the user.

Geo-fencing (also known as virtual fencing) is a type of location based services that involves tracking the location of a mobile device, defining geographical boundaries into virtual boundaries delineated by virtual fences (geo-fences), and providing notifications such as reminders, updates or recommendations based on proximity to locations and/or virtual boundaries. For instance, a user may receive an alert or notification at a mobile device when entering or leaving the vicinity of a geo-fenced boundary, or moving about within a geo-fenced boundary.

However, present geo-fencing techniques are limited in several ways. First, boundaries are defined based on exact longitudes and latitudes. Second, since location awareness relative to geo-fences are determined on the client device, the client device has to track its location on an ongoing basis in order to determine its current location and the relation to the geo-fenced areas. For instance, determining a mobile device's location may involve actively monitoring satellite signals or frequently scanning the proximate wireless networks to determine a position signal or whether the mobile device is within the range of a certain wireless network. Such monitoring and scanning can consume a substantial amount of computing resources such as power and data bandwidth.

Hence, there exists a need for virtual fencing techniques that allow for a variety of applications, for example, applications not dependent on the precise location information of a mobile device, as well as applications less concerned about consuming excessive computing resource on a mobile device.

### BRIEF DESCRIPTION OF THE DRAWINGS

Various embodiments of the invention are disclosed in the following detailed description and the accompanying drawings.

FIG. 1 is a flowchart illustrating an example process for virtual fencing, in accordance with one or more embodiments of the present disclosure.

FIG. 2 is a flowchart illustrating another example process for virtual fencing, in accordance with one or more embodiments of the present disclosure.

FIG. 3 is a diagram illustrating yet another example process for virtual fencing, in accordance with one or more embodiments of the present disclosure.

FIG. 4 is a functional diagram illustrating an embodiment of a system for virtual fencing, in accordance with one or more embodiments of the present disclosure.

FIG. 5 is a functional diagram illustrating an embodiment of a programmed computer system for virtual fencing, in accordance with one or more embodiments of the present disclosure.

FIG. 6 is a functional diagram illustrating an embodiment of an in-vehicle system for virtual fencing, in accordance with one or more embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure can be applied to one or more dedicated and/or general purpose computing devices including, but are not limited to, personal computers, servers, hand-held devices, portable devices, tablet devices, wearable devices, mobile phones, smart phones, in-vehicle devices, multi-processor devices, and distributed computing environments including any combinations thereof.

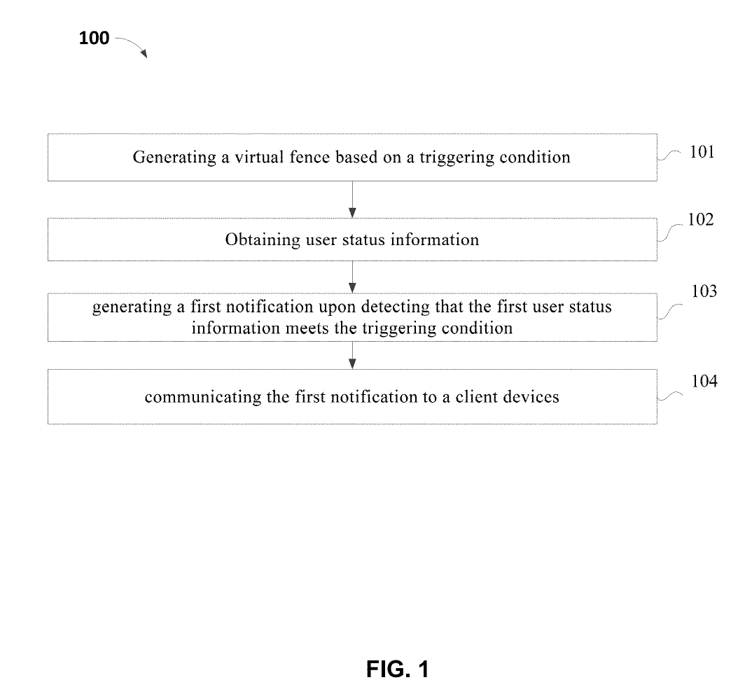

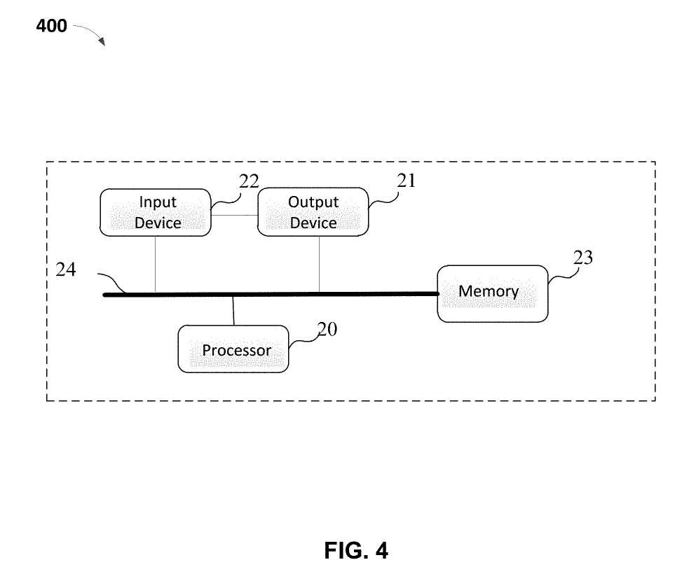

FIG. 1 illustrates a flow chart of an example process for virtual fencing, in accordance with an embodiment of the present disclosure. Process 100 can be implemented by, for examples but not limited to, system 400 of FIG. 4.

According to various embodiments of the present disclosure, a system of virtual fencing includes a server and a client device. In this example, the server is configured as a LBS server that provides location-based services to a plurality of client devices, and the client is a LBS client device configured to interact with the LBS server. Here, process 100 is illustrated from the server's perspective in terms of providing virtual fencing.

Process 100 starts at 101, where a virtual fence is generated at the server. In this example, a virtual fence is generated by the process. First, fence configuration information input by a user using a third-party computing device, such as a server, is received. Fence configuration information includes one or more triggering conditions.

Second, a virtual fence is generated based on the fence configuration information.

In some embodiments, the server can communicate with one or more third-party servers that are not part of the virtual fencing system. These third-party servers can be configured to provide third-party applications that may or may not depend on or make use of the features and functionalities of the virtual fencing system. For example, such third-party application can be a smart home service controlling the smart appliances, power system, lighting system and air conditioning system regardless of any input of location information. For such a third party application, the third-party server is a smart home server configured to provide smart home services to its respective client systems.

Embodiments of the present disclosure can be applicable to many types of third-party applications, for example, any applications that are installed and capable of being executed on a mobile device.

In one embodiment, a third-party server provides an interface supplied by the LBS server to a user for the purpose of configuring fence set-up information. In this scenario, the user interacts with the interface to directly provide the fence configuration information to the third-party server.

Therefore, the third-party server in turn forwards the user fence configuration information to the correspondent LBS server, which is configured to generate the corresponding virtual fence based on the fence configuration information. In some other embodiments, the LBS server transmits the fence configuration information received from the third-party server to a client device, causing the client device to synchronously generate the corresponding virtual fence.

In yet some other embodiments, a third-party application provides an interface supplied by the LBS client to a user for the purpose of configuring user fence information. Here, the user specifies the fence configuration information by interacting with the third-party application. After the third-party application receives the fence configuration information from the user, it transmits the fence configuration information to the server, for example, via the client device.

According to various embodiments of the present disclosure, fence configuration information includes, but is not limited to, trigger conditions and validation conditions.

Trigger conditions as used herein refers to conditions in response to which the virtual perimeter of a virtual fence are defined. For example, triggering conditions include conditions pertaining to, but are not limited to, point-of-interest (POI) information, area-of-interest (AOI) information, designated user behavior information, or the like. In one example, a virtual fence can be defined using the POI as the center of a circle of a pre-defined radius. When the user device comes within the radius distance to the POI, or in the other words, enters the virtual perimeter, the virtual fence is considered “triggered” and a notification is generated and sent to the user device. In another example, a virtual fence can be specified using the AOI as the center area of a region having a similar shape extended of a pre-defined distance. Again, when the user device enters the region encompassing the AOI, the virtual fence is considered triggered and a notification is generated and sent to the user.

POI, also known as “navigation map information,” can be a is a landmark or site on a map used to identify a government facility, a business (a gas station, department store, supermarket, restaurant, hotel, convenience store, hospital, etc.), a tourist site (a park, public restroom, etc.), a historic site, a transportation related facility (a bus station, train station, parking lot, speeding enforcement camera, speed limit sign, etc.), or the like. In some embodiments, a POI includes four types of information: the name of a POI, the category a POI belong to, a pair of longitude and latitude coordinates of a POI, and one or more businesses such as hotels, eateries, and stores in the vicinity of a POI.

AOI as used herein refers to a geographical area.

Designated user behavior information as used herein refers to information pertaining to users' motions or activities or transportation modes such as running, biking, jogging, driving, etc.

According to various embodiments of the present disclosure, triggering conditions include not only POIs, but also AOIs and user behavior information, thereby expanding the types of virtual fences that can specified by the user. As a result, virtual fences are defined not only relative to geo-areas having coordinate information, but also are defined relative to context fences. For example, an event fence (illustrated in below) is a type of context fence which uses contextual information, such as a point of time, a period of time and users' activities, to define a fence that is configured to be triggered when the designated contexts are identified.

In the following example, a virtual fence is designated as one of the following five (5) types:

1) point-of-interest fence and area-of-interest fence such as “airport,” “scenic area,” “mall,” “restaurant,” “café,” “movie theater,” etc.;

2) road fence designated according to their classifications, e.g., “express way,” “national highway,” “rural road,” or “detour route,” etc.;

3) road fence designated according to their names, e.g., “Hongtai East Street;”

4) route fence of specified series of roads, e.g., “home route,” ‘workplace route,” etc.

5) event fence designated according to specific information, which includes, but is not limited to, a specific period of time (e.g., holidays), a specific user activity (being still, walking, running, jogging, biking, driving, etc.), price information at a certain location, review information regarding a certain location, etc.

It should be noted that a virtual fence of one of the above-described types can be designated with one or more other types of fences. For example, a workplace route fence can include a plurality of road fences for a certain time frame (e.g., rush hour) fence, or another plurality of road fences for another time frame (e.g., non-rush hour) fence.

In other embodiments, other types of virtual fences can be used.

Validation conditions related to a virtual fence are configured as conditions under which a virtual fence is considered active or effective, regardless of whether or not the virtual fence is triggered by a user. In other words, only an effective virtual fence can be triggered. Validation conditions include, but are not limited to, the expiration information related to the virtual fence, the threshold number of times the triggering conditions have been met in the past, and the like. The expiration information as used herein refers to the period of time in which the virtual fence is effective in terms of being utilized to generate notifications for the users. When outside of an expiration timeframe, a virtual fence is considered ineffective during that period of time and is no longer used to send users notifications. Expiration can be a certain date in the future, or a certain period of time specified for every day, week, month, etc. For example, an expiration can be configured as before 9 am and after 7 pm for a virtual fence of home. When the user device comes within the virtual fence of home between 9 am to 7 pm, the geo-fence is inactive and no notifications are generated so that no actions associated with the fence are to be taken. The threshold number of times the triggering conditions have been met refers to a pre-configured number of times that a virtual fence can be triggered. Before reaching the threshold number, a virtual fence is considered effective and can be triggered by the right condition. Once the number of time the virtual fence is triggered exceeds the threshold, the virtual fence is considered ineffective and cannot be triggered any more.

Referring back to FIG. 1, at 102, user status information is collected.

Once a virtual fence is generated by the LBS server, the existence of a virtual fence indicates that there is a virtual fence based task to be executed in order for the LBS server to detect or recognize a triggering condition configured for the virtual fence is met. Therefore, from the point a geo-fence is generated, the LBS server starts to collect user status information in order to determine whether or not the triggering condition is met.

The user status information includes first location data and/or first behavior data. The first location data includes information specifying the current geo-location of a mobile device of a user. The first behavior data includes information related to a user's current activities or motion status (e.g., being still, walking, running, biking, or driving). For example, the LBS server can analyze how frequently or how quickly the location information of the user changes so as to determine the motion of the user. For example, if there is no change at all, the user is determined to be in a still state. For another example, if the rate at which the user location changes is over 60 miles per hour, the user is determined to be driving.

In one example, the LBS server uses a Wi-Fi probe to collect location information of a mobile device. Using the wireless broadcast signals from the mobile device's Wi-Fi module, the LBS server can detect the mobile device and collect the location data related to the sites the user of the mobile device has visited. Then, the LBS server analyzes the data recorded by the probe technique so as to, for example, detect whether the user is in motion or not, recognize which commercial zone or stores the user's location is proximate to and therefore is representative of.

It should be noted that the afore-mentioned example is only for the purpose of illustration, any suitable technologies for determining a mobile device’ location are applicable to embodiments of the present disclosure.

Using big data analysis techniques to determine the user location information as well as to analyze user behavior for the purposes of obtaining user status information, the LBS server is configured with an increased a variety of ways to obtain data from a variety of sources, thereby conserving the computing resources that are devoted on the client device for location determination.

At 103, in response to determining that the user status information meets the triggering condition of the virtual fence, a first notification is generated.

Once obtaining the user status information, the LBS server starts to scan through the virtual fences generated in order to determine whether a virtual fence can be recognized. Further, upon recognizing a virtual fence for the user, the LBS server is configured to determine whether the obtained user status information meets any triggering conditions associated with the virtual fence.

The following is an example of determining whether the user status information satisfies a triggering condition of a virtual fence. However, it should be noted that any suitable technologies can be applied to determine whether a triggering condition of a virtual fence is met by user status information.

When the location data of the user status information indicates that the mobile device of the user is at the POI configured for the virtual fence, or the mobile device is within the range of the AOI configured for the virtual fence, and/or the user behavior data of the user status information matches the designated user behavior information associated with the triggering condition for the virtual fence, it is determined that the user status information satisfies the trigger condition of the virtual fence.

Further, when the location data of the user status information indicates that the mobile device of the user is not at the designated POI, or the mobile device is not within the range of the designated AOI, and/or the user behavior data of the user status information does not match the designated user behavior information associated with the triggering condition for the virtual fence, it is determined that that the first user status information does not satisfy the trigger condition of the virtual fence.

In particular, with a trigger condition specified only as a POI or an AOI, when the location data indicates the device is at the POI or within the range of the AOI configured by the user, it is determined that the user status information satisfies the triggering condition of the virtual fence. In other words, the user has entered the virtual fence configured using the POI or AOI. Otherwise, it is determined that the first user status information does not satisfy the triggering condition of the virtual fence. Taking a context fence for example, a context fence is first configured to be triggered when the user is in the district of Wangfujing. Then, when detecting that the current location of the user is in the district of Wangfujing, the LBS server determines that the triggering condition of the context fence has been satisfied.

Alternatively, with the triggering conditions specified as a POI or an AOI together with designated user behavior information, in addition to that the location data indicates the mobile device of the user as at the POI or within the range of the AOI configured by the user, when the first behavior data matches designated user behavior information, it is determined the user status information meets the triggering condition of the virtual fence configured using the POI or AOI, as well as the user behavior information. Otherwise, if the location data indicates the mobile device is not at the POI, or not within the range of the AOI configured by the user, or even though the first location data indicates that the mobile device is at the POI or within the range of the AOI configured by the user, when the first behavior data does not match the designated user behavior information, it is determined that the user status information does not satisfy the triggering condition of the fence.

Taking another context fence for example, first, a context fence is configured to be triggered when the user is running at a fitness center. Then, when the LBS server detects that the user's current location is at a fitness center and that the user is running, it is determined that the triggering condition of this virtual fence has been met. If the LBS server recognizes that the user's current location as a fitness center, but detects that the user is not running, it is determined that the triggering condition of this virtual fence has not been satisfied.

Upon determining that the user status information satisfies a trigger condition of the virtual fence, the LBS server is configured to generate a first notification. In one embodiment, the first notification includes, but is not limited to, a virtual fence identifier, the user behavior data, the location data, and the fence configuration information. In some embodiments, such notification can be take the form of messages.

At 104, the first notification is transmitted to a client device.

After the LBS server generates the first notification, it forwards the first notification to a client device configured to receive services from the LBS server.

In some embodiments, the LBS server further receives a second notification sent from the client device.

In particular, the LBS server and the client device are configured to communicate with regard to the fence recognition result, thereby increasing the accuracy in recognizing virtual fences. In addition to forwarding the first notification to the client, the server subsequently receives a second notification from the client device.

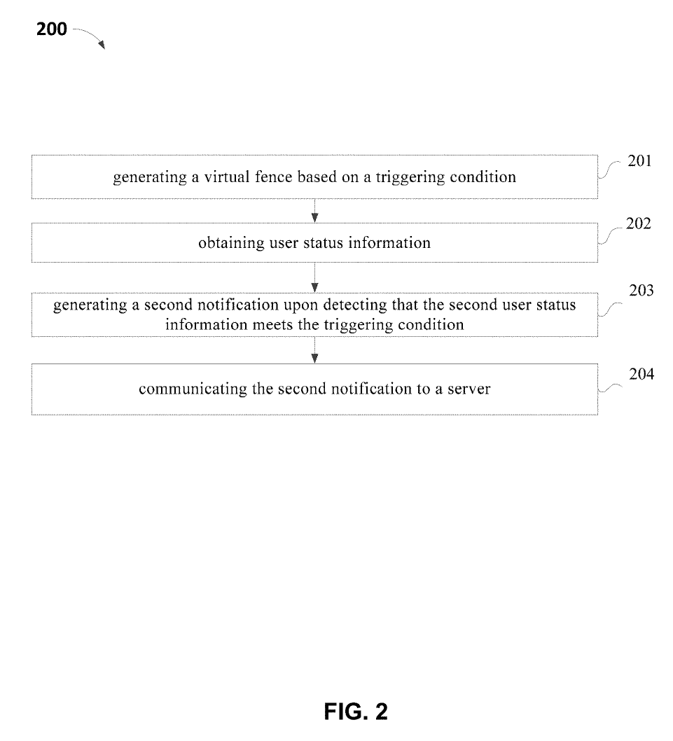

In this example, the second notification is generated after the client device has generated a virtual fence based on the triggering conditions, acquired user status information, and determines that the client device obtained user status information meets the triggering condition. The generating and detecting of the triggering of a virtual fence on the client device are illustrated in further details with reference to FIG. 2.

In some embodiments, triggering conditions are configured to correspond to designated operations. In particular, when the first notification or the second notification are forwarded to a third-party server, the third-party server is configured to execute the designated operation corresponding to the triggering conditions based on the first notification or the second notification.

In particular, the fence configuration information further includes information pertaining to designated operations that correspond to the triggering conditions and are executed when the correspondent triggering conditions are satisfied. For example, the designated operations can be a command to operate an electrical appliance, a command to deliver a message, etc.

In particular after the LBS server generates a first notification or receives a second notification, it sends the first notification or second notification to a third-party server, which in turn executes the designated operations corresponding to the first and/or second notifications.

Taking a context fence for example, first, the context fence is configured by a user with a triggering condition as to “automatically turn on air-conditioning when 500 meters away from home” and the LBS server starts to collect the user's user status information. When the LBS server, upon detecting that the user is 500 meters away from home, determines that the triggering condition of the context fence has been satisfied and then generates a first notification. The first notification is transmitted to a third-party server, which turns on the air-conditioning of the home upon receiving the first notification, which indicates the operation as turning the air conditioning on.

In some cases, the first notification is consistent with the second notification; in some other cases, the first notification message is not consistent with the second notification. As used herein, a first notification is considered consistent with a second notification if the location data in the first notification and the second notification is the same, and/or the behavior data in the first notification and the second notification is the same.

When the first notification is consistent with the second notification, either notification is selected for being transmitted to a third-party server.

When the first notification is not consistent with the second notification, the following illustrates an example of the LBS server determining whether the first notification or the second notification is to be forwarded to a third-party server.

First, a first precision level associated with the first notification and a second precision level associated with the second notification is obtained. Such precision levels indicate a degree of accuracy with respect to the data in the notifications. For example, a precision level can be configured as 80% to indicate that the data provided is correct 80% of time. Therefore, data collected at a precision level of 80% is considered more reliable than data collected at a precision level of 50%. If the first precision level is greater than (e.g., indicating a greater probability that the data is reliable) said second precision level, it is determined that the first notification is more reliable and therefore is forwarded to the third-party server. On the other hand, if the first precision level is lower than (e.g., indicating a lower probability that the data is reliable) the second precision level, it is determined that the second notification is more reliable and therefore is forwarded to a third-party server.

In some embodiments, the first precision level of the first notification can be configured by the LBS server, while the second precision level of the second notification can be configured by the LBS client.

For example, the precision level at the LBS server side can be a probability of accurate location determination by the server, which is computed by comparing the location information obtained on several occasions with the correspondent known location information. Likewise, the precision level at the LBS client can be a probability of accurate location determination by the client device, which is computed by comparing the location information obtained on several occasions with the correspondent known location information.

Furthermore, when it is determined that the user status information does not meet the triggering condition of a virtual fence, it is further determined whether the virtual fence is still effective or valid under the validity conditions associated therewith. When the user status information is determined as not meeting any triggering condition of a virtual fence, the validation condition is used to determine whether or not to continue to maintain the virtual fence and the collection of user status information therefore. If it is determined that the validation condition of the virtual fence is met despite that none of the triggering condition is, the LBS server continues to collect the user status information for the virtual fence. If it is determined that the validation condition of the virtual fence is not met, the LBS server deletes the virtual fence from the system and stop collecting user status information.

Taking a validation condition configured with expiration information and a threshold number of times that the virtual fence can be triggered for example, both the expiration information and the threshold number are considered in order to determine whether the virtual fence is still valid. If the current point of time is determined to render the virtual fence into expiration, or if the virtual fence has been triggered for a number of times that exceeds the threshold number, the virtual fence is determined as invalid and is to be deleted at the LBS server.

If the virtual fence has not expired according to the expiration information, and if the number of times the virtual fence has been triggered does not exceed the threshold number, the virtual fence is determined as valid, in which case, the LSB server continues to collect user status information in order to monitor whether the virtual fence is to be triggered.

In some embodiments, the user interacts with a third party application or a third party server, for example, the application or the server by which the user has provided a virtual fence configuration information, to delete an existing valid fence. After receiving the correspondent messages from the third party application or third party server, the LBS server deletes the corresponding fence.

According to various embodiments of the present disclosure, virtual fences can be provided not only at a service level, but also at an operating system level, which supplies for interfaces to other third party application or service developers to develop third party applications or services using virtual fences.

For example, a music-playing application can be configured with the capability to receive a context notification such as “the user is now running in the Olympic Forest Park.” Upon being notified with this context, the music-playing application is configured to provide the user at this context with the context-based content and services. For another example, a travel application can be configured to receive a notification indicating that “the user has left the city of residence and is now traveling.” Upon receiving the notification, the travel application is configured to actively send information pertaining to air ticket purchasing and hotel booking to the user in transit. For yet another example, a restaurant application can be configured to receive a notification indicating that “the user has arrived at XYZ shopping center; and now it is mealtime; it is likely the user is looking for a restaurant.” Upon receiving a notification, the restaurant application can be configured to send to the user the recommended restaurant information, customer review information, etc.

In some embodiments, virtual fences are likewise applicable to promotional events, workplace or enterprise settings. For example, when a triggering condition is met and indicates that the context as “the user is at a conference,” the most updated conference and venue information can be pushed to the user.

With the LBS server taking advantages of the big data infrastructure to generate virtual fences and to detect user location on the server side, fence recognition efficiency can be improved, as well as power conservation on the client device as the client device is freed from on-going location positioning and fence monitoring.

Furthermore, with the LBS server and the LBS client both configured to detect fence triggering recognition, as well as the LBS server and the LBS client communicating respective fence recognition results to each other, the accuracy in fence triggering is further enhanced.

FIG. 2 illustrates a flowchart of an example process for virtual fencing on a client device, in accordance with an embodiment of the present disclosure. Process 200 can be implemented by, for example but is not limited to, system 400 of FIG. 4.

Process 200 starts at 201, where a virtual fence is generated at a client device.

In some embodiments, the following steps are performed in order to generate a virtual fence. First, the client device is configured to receive fence configuration information from a LBS server, which receives the fence configuration information from another server and in turn transmits the received information to the client device. Then, a virtual fence is generated based on the fence configuration information.

According to various embodiments of the present disclosure, the LBS server is configured to communicate with an application server, which can be a server servicing a third-party application or services. For example, with a third-party application as a smart home application, the third-party server is a smart home server providing smart home services. Further, third party applications can be other third party applications installed and executable on a terminal device, such as maps applications, travel booking applications, etc.

In one embodiment, a third-party server provides an interface supplied by the LBS server to a user for the purpose of configuring fence set-up information. In this scenario, the user interacts with the interface to directly provide the fence configuration information to the third-party server.

After receiving the fence configuration information forwarded from a third-party server, an LBS server relays the fence configuration information to a client device. Thus, after the client device receives the fence configuration information, a virtual fence based thereon is created on the client side accordingly.

In some other embodiments, the client device is configured to receive fence configuration information entered by a user through a third-party application, the fence configuration information including triggering conditions. Upon receiving the fence configuration information, a virtual fence is generated based on said fence configuration information.

In yet some other embodiments, a third-party application provides an interface supplied by the LBS client to a user for the purpose of configuring user fence information. Here, the user specifies the fence configuration information by interacting with the third-party application. After the third-party application receives the fence configuration information from the user, it transmits the fence configuration information to the client so that the client generates a virtual fence based on the fence configuration information.

Again, fence configuration information includes, but is not limited to, trigger conditions and validation conditions. Details regarding the triggering condition (POIs, AOIs, fence types, etc.) and validation are similar to those described with reference to FIG. 1 and are not repeated herein for purpose of simplicity.

At 202, the user status information is obtained at the client device.

Similarly, after a virtual fence is generated at the client device, the existence of a virtual fence indicates that there is a virtual fence based task to be executed in order for the LBS client to detect or recognize a triggering condition configured for the virtual fence is met. Therefore, from the point a geo-fence is generated, the LBS client starts to collect user status information in order to determine whether or not the triggering condition is met.

Similar to the user status information obtained by the server, the user status information obtained at the client device also includes location data and/or behavior data. The location data includes information specifying the current geo-location of a mobile device of a user. The behavior data includes information related to a user's current activities or motion status (e.g., being still, walking, running, biking, or driving).

In some embodiments, the LBS client is configured to obtain user status information based on beaconing data and sensor data available at the device. For example, the user location information can be obtained by GPS, or through the telecommunications network servicing the client device, or the combination thereof.

In addition, the client device can be configured to obtain location data using Wi-Fi hotspot information. In general, Wi-Fi hotspot information includes detailed geo-location information for the hotspot. When connecting to the Wi-Fi hotspot network, the client device can acquire its positioning data derived from the location information of the Wi-Fi hotspot it currently connects to.

With regard to user behavior data, various sensor on the client device can be used to obtain various data about the user of the device. For example, a speedometer can be used to analyze the user's present motion status: e.g., being still, walking, running, biking, driving, etc. Again, it should be noted that any suitable technologies can be used to obtain user status information on the client device.

Furthermore, user behavior data obtained at the client device can be used to determine whether user location data need to be obtained. For example, if the user is detected as in the mode of being still, there is no need, after acquiring the user location data once, to acquire user location data again until the behavior data changes to indicate that the user has moved. Thus, both power and data bandwidth dedicated to obtain location information on the client device can be saved.

At 203, a second notification is generated when it is determined that the obtained user status information satisfies the triggering condition of a virtual fence.

Once obtaining the user status information, the LBS client starts to scan through the virtual fences generated in order to determine whether a virtual fence can be recognized. Further, upon recognizing a virtual fence, the LBS client is configured to determine whether the obtained user status information meets any triggering conditions associated with the virtual fence.

Again, the details regarding how the client device determines whether the user status information satisfies the triggering condition of the virtual fence is similar to these described with reference to FIG. 1, and therefore are not repeated herein.

Upon determining that the user status information satisfies a trigger condition of the virtual fence, the LBS client is configured to generate a first notification. In one embodiment, the first notification includes, but is not limited to, a virtual fence identifier, the user behavior data, the location data, and the fence configuration information. In some embodiments, such notification can be take the form of messages.

At 204, the second notification is transmitted a server.

After the LBS client generates the second notification, it sends the second notification to the LBS server.

In some embodiments, the client device is further configured to receive a first notification message sent by the server.

Again, with the client and the server communicating with each other with regard to the fence recognition result, fence recognition accuracy is increased. In addition to sending the second notification to the server, the client also receives a first notification from the server.

As described before, the first notification is generated after the server has generated a virtual fence based on the trigger conditions, has collected user status information, and has determined that the user status information meets the trigger conditions.

Details of fence recognition by the client device is similar to the description with reference to FIG. 1, and therefore are not repeated herein.

Similarly, in some embodiments, triggering conditions are configured to correspond to designated operations. When the first notification or the second notification are forwarded to a third-party server, the third-party server is configured to execute the designated operation corresponding to the triggering conditions based on the first notification or the second notification.

In particular, after a client generates a second notification on its own or receives a first notification from the server, the second notification or the first notification is sent to a third-party application, which in turn forwards the second notification or first notification to a third-party server for execution of the designated operation.

Taking the same context fence for example, first, the context fence is configured by a user with a triggering condition as to “automatically turn on air-conditioning when 500 meters away from home” and the LBS client starts to collect the user's user status information. When the LBS client, upon detecting that the user is 500 meters away from home, determines that the triggering condition of the context fence has been satisfied and then generates a second notification. The second notification is transmitted to a third-party server, which turns on the air-conditioning of the home upon receiving the second notification, which indicates the operation as turning the air conditioning on.

Again, in some cases, the first notification is consistent with the second notification; in some other cases, the first notification message is not consistent with the second notification. Details regarding how to determine whether the first notification or the second notification is to be forwarded for executing the designated operations are similar to those described with reference to FIG. 1, and therefore are not repeated herein.

Further similarly, when it is determined that the user status information does not meet the triggering condition of a virtual fence, it is further determined whether the virtual fence is still effective or valid under the validity conditions associated therewith. Once detecting an invalid virtual fence, the client device also deletes the fence and stops monitoring for fence triggering. Again, details of the determination is similar to those described with reference to FIG. 1, and therefore are not repeated herein.

Furthermore, with the LBS client detects fence triggering recognition, it is also configured to reference synchronous recognition results sent from the server. With the LBS server and the LBS client both configured to detect fence triggering recognition, as well as the LBS server and the LBS client communicating respective fence recognition results to each other, the accuracy in fence triggering is further enhanced at the client device as well.

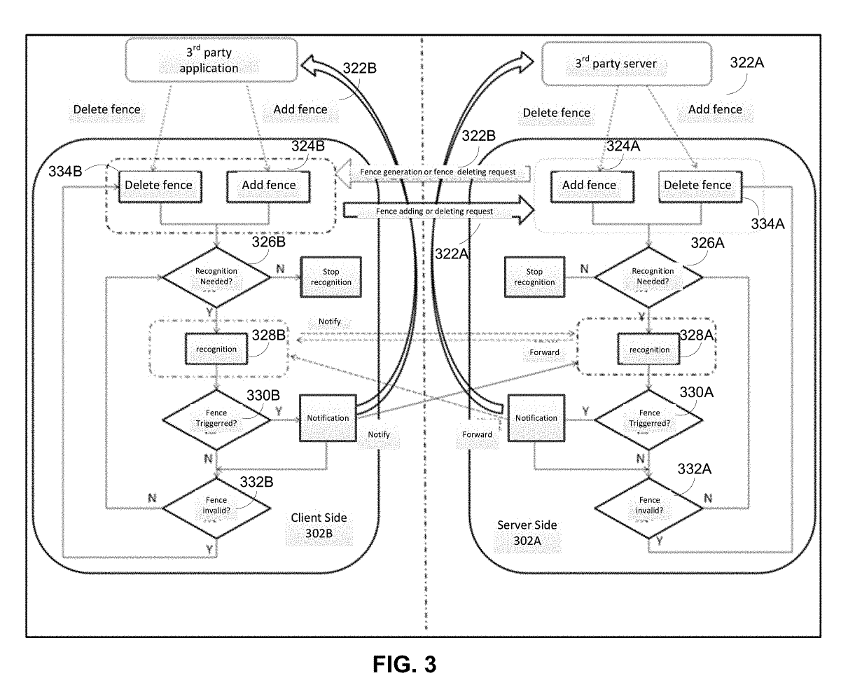

FIG. 3 illustrates a diagram of an example virtual fence, in accordance with an embodiment of the present disclosure. In this example, a virtual fence based system 300 includes both a server side fence based system 302A and a client device side fence based system 302B. With both the server and the client simultaneously detecting virtual fence recognition and communicating the recognition results to each other, system 300 achieves increased accuracy in fence triggering or recognition.

In client device side fence based system 302B, the client device is configured to receive a virtual fence generation request from a third-party application or from a server at 322B, the fence generation request includes information such as fence configuration information as described with reference to FIGS. 1 and 2.

Next, at 324B, the client device is configured to add a corresponding virtual fence at the client device based on the fence configuration information included in the received virtual fence generation request.

Afterwards, at 326B, the client device is configured to determine whether any virtual fence based task is to be executed for fence recognition. For example, if there is a context fence generated on the client device, it is determined that there is a virtual fence based task that is to be monitored for recognition or triggering. Otherwise, it is determined that there is no such fence based task to be monitored. In response to the determination that there is no virtual fence based task, the client device stops detecting fence triggering.

Next, at 328B, in response to the determination that there is a fence based task on the client side, the client device is configured to start context fence recognition, as well as to collect the user status information, which is used to determine whether the user status information meets the triggering condition of the virtual fence. Next, at 330B, in response to the determination that the triggering condition of the virtual fence is met, a first notification is generated and transmitted to a third-party application and the server side of the fence based system 302A.

In response to the determination that the triggering condition of the virtual fence is not yet met, at 332B, it is further determined whether the virtual fence is invalid by, for example, checking the validation information configured therefor, if it is determined that the virtual fence is no longer valid, at 334B, the fence is deleted from the client device. Otherwise, the client device goes back to 326B to determine whether there is a virtual fence based task for monitoring.

In addition, at 322B, the client device is configured to receive a fence deletion request, from a third-party application or the server side fence based system 302A, to delete the corresponding fence.

On the other hand, in the server side fence based system 302A, at 322A, the server is configured to receive a virtual fence generation request from a third-party server or from client side fence based system 302B. The fence generation request includes, for example, fence configuration information as described with reference to FIGS. 1 and 2.

Next, at 324A, the server is configured to add a corresponding virtual fence at the server based on this fence configuration information.

Afterwards, at 326A, the server is configured to determine whether any fence based task is to be executed for fence triggering or recognition. For example, if there is a context fence generated on the server side, it is determined that there is a fence based task for recognition; otherwise, it is determined that there is no fence based task for recognition, and consequently the server stops recognizing any virtual fences.

Next, at 328A, in response to the determination that there is a fence based task for recognition, the server is configured to start context fence recognition, as well as to collect user status information, which is used to determine whether the user status information satisfies the triggering condition of the virtual fence.

At 330A, in response to the determination that the triggering condition is met, the server generates a second notification and sends the second notification to the third-party server and client side fence based system 302B.

At 332A, in response to the determination that the triggering condition is not met, it is further determined whether the context fence is valid according to the validation information configured for the virtual fence. If it is determined that the virtual fence is no longer valid, at 334A, the fence is deleted in sever side fence based system 302A. Otherwise, the server goes back to 326A to determine whether there is any fence based task for monitoring.

In addition, at 322A, the server is further configured to receive a fence deletion request, from a third-party server or client side fence based system 302B, to delete the corresponding fence.

According to various embodiments of the present disclosure, context fence based features can be provided to a developer in the form of an operating system in addition to various applications and services.

In addition to the above-described diversity in the virtual fences, embodiments of the present disclosure further provides for the following advantages over a traditional geo-fence:

1. Context fences can be configured using area-of-interest in addition to points-of-interest.

2. Triggering conditions of a context fence can be configured without using a client application.

3. Context fences are not limited to a virtual fence having precise latitude and longitude coordinates. As described above, a virtual fence can be a fence based on a certain event, e.g., whether a user is engaged in a certain activity, or whether the present time is within a certain time frame. Further, fences can also be configured using a roads or routes designated according to category thereof, or using subjective or objective evaluation or review information

4. A combination of fence recognition and user status information determination on both the client device and the server, as well as the communication of the fence recognition results between the client device and the server, achieves increased accuracy in terms of fence detecting and recognition.

FIG. 4 illustrates a functional diagram of an embodiment of a computing system for virtual fencing, in accordance with an embodiment of the present disclosure. System 400 can be a standalone device, an integrated in-vehicle sub-system of a vehicle (e.g., an automobile, an aircraft, a ship, etc.), or a standalone in-vehicle system. Computing system 400 can be used to implement processes of FIGS. 1-3, as appropriate. As will be apparent, other computer system architectures and configurations can be used to implement the systems and methods for virtual fencing. Computing system 400 includes a processor 20, an output device 21, an input device 22, memory 23, and at least one communication bus 24.

Communication bus 24 is for implementing inter-component communication connections. Memory 23 may contain high-speed RAM memory. It contains non-volatile memory (NVM), such as at least one magnetic disk storage device. Memory stores various programs used to instruct various processes to be executed by computing system 400.

Alternatively, the aforesaid processor 20 can be implemented as a central processing unit (CPU), an application-specific integrated circuit (ASIC), a digital signal processor (DSP), a digital signal processing device (DSPD), a programmable logic device (PLD), a field-programmable gate array (FPGA), a controller, a microcontroller, a microprocessor, or another electronic component. The processor 20 is coupled to the aforementioned input device 22 and output device 21 through in-car wiring or a wireless connection.

Alternatively, input device 22 comprises multiple input devices. For example, it comprises at least one of the following: a user-oriented user interface, a device-oriented device interface, and a transceiver. Alternatively, the device-oriented device interface is a wired interface for conducting device-to-device data transmissions, or a hardware insertion interface (e.g., a USB interface, a serial port, an interface between automotive hardware installations, etc.) for conducting device-to-device data or instruction transmissions. Alternatively, the user-oriented user interface is, for example, user-oriented control keys, a voice input device for receiving voice input, or a touchscreen perceiving device (such as a touchscreen or a touch tablet have touch-sensing functions). Alternatively, the transceiver described above is a radio-frequency transceiver chip, a baseband chip, or a transceiver antenna. Alternatively, output device 21 is a corresponding output interface with communication functions or a voice playback device or a transceiver.

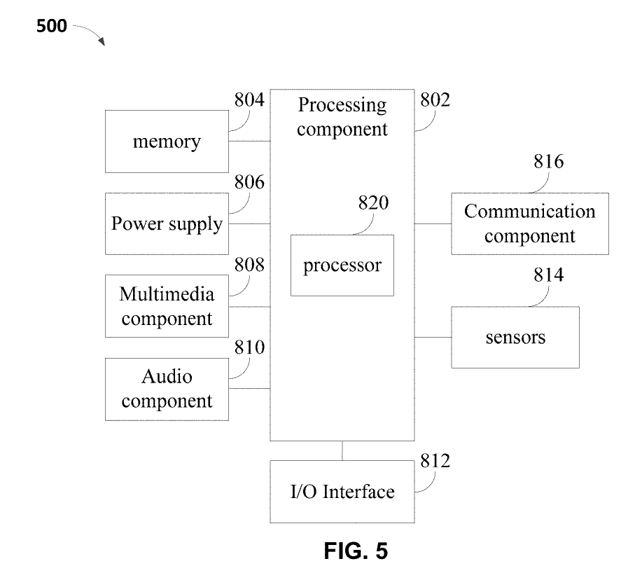

FIG. 5 illustrates a functional block diagram of another embodiment of a programmed computer system for virtual fencing, in accordance with an embodiment of the present disclosure. Computing system 500 can be used to implement processes of FIGS. 1-3, as appropriate. As will be apparent, other computer system architectures and configurations can be used to implement the systems and methods for virtual fencing. Computing system 500 can be used to implement in-vehicle systems such as an aircraft system, etc. Computing system 400 includes a processing component 802, memory 804, a power supply component 806, a multimedia component 808, an audio component 810, an input/output (110) interface 812, a sensor 814, and a communication component 816.

The processing component 802 generally controls overall operations of system 500, such as operations relating to display, telephone calls, data communications, camera operations, and recording operations. In addition, the processing component 802 may comprise one or more modules to facilitate interaction between the processing component 802 and other components. For example, the processing component 802 may comprise a multimedia module to facilitate interaction between the multimedia component 808 and the processing component 802.

The memory 804 is configured to store all kinds of data in support of system 500 operations. Examples of this data include the instructions of any application program or method used in system 500 operations, contact data, telephone directory data, messages, pictures, and video. The storage device 804 can be any combination of volatile or non-volatile memory, such as static random access memory (SRAM), electrically erasable programmable read-only memory (EEPROM), erasable programmable read-only memory (EPROM), programmable read-only memory (PROM), read-only memory (ROM), magnetic storage, flash memory, magnetic disks, or optical disks.

The power supply component 806 provides electric power to the various components of system 500. The power supply component 806 can include a power supply management system, one or more power supplies, and other components related to generating, managing, and allocating power to system 500.

The multimedia component 808 comprises an output interface screen provided between system 500 and the user. In some embodiments, the screen may comprise a liquid crystal display (LCD) or a touch panel (TP). If the screen comprises a touch panel, the screen may be implemented as a touchscreen to receive input signals from the user. The touch panel comprises one or more touch sensors to detect touches, sliding actions, and gestures on the touch panel. Said touch sensor can not only detect the boundaries of touch or slide actions, but also can measure duration and pressure related to said touch or slide operations. In some embodiments, the multimedia component 808 may further comprise a front camera.

The audio component 810 is configured to output and/or input audio signals. For example, the audio component 810 includes a microphone (MIC). When system 500 is in an operating mode, e.g., when in calling mode, recording mode, or voice recognition mode, the microphone is configured to receive external audio signals. The received audio signals can be further stored in the storage device 804 or sent by the communication component 816. In some embodiments, the audio component 810 further comprises a speaker for output of audio signals.

The 110 interface 812 provides an interface between the processing component 802 and peripheral interface modules. The aforesaid peripheral interface modules may be keyboards, click wheels, buttons, etc. These buttons may include but are not limited to: volume button, start button, and lock button.

The sensor component 814 comprises one or more sensors and is used to provide status evaluations of various aspects of system 500. In some embodiments, the sensor component 814 may further comprise an acceleration sensor, a gyroscopic sensor, a magnetic sensor, a pressure sensor, or a temperature sensor.

The communication component 816 is configured to facilitate wired or wireless communication between system 500 and other devices. System 500 may access wireless networks based on a communications standard such as Wi-Fi, 2G, 3G, or combinations thereof. In an exemplary embodiment, the communication component 816 receives via broadcast channels broadcast signals or broadcast-related information from external broadcast management systems. In an exemplary embodiment, said communication component 816 further comprises a near-field communication module for promoting short-range communication. For example, it can be achieved in the NFC module on the basis of radio-frequency identification (RFID) technology, Infrared Data Association (IrDA) technology, ultra-wide band (UWB) technology, Bluetooth (BT) technology, and other technology.

In an exemplary embodiment, system 500 can be realized by one or more application-specific integrated circuits (ASIC), digital signal processors (DSP), digital signal processing devices (DSPD), programmable logic devices (PLD), field-programmable gate arrays (FPGA), controllers, micro-controllers, microprocessors, or other electronic components for executing the virtual fence-based information-processing method described above.

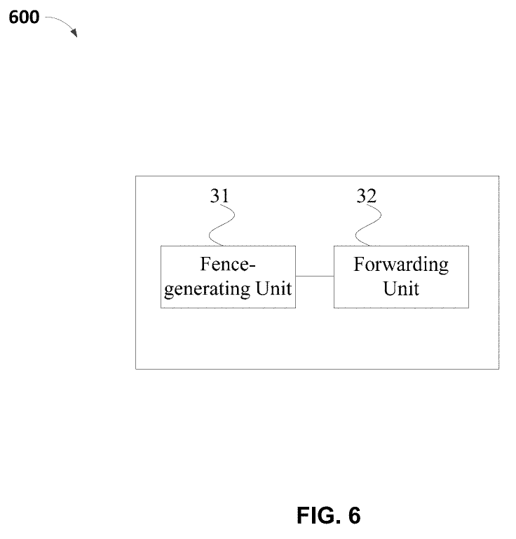

In particular, system 500 can be used to implement an in-vehicle system, which is illustrated in further details with reference to FIG. 6. For an in-vehicle system, computing system 500 further comprises an onboard input device, an onboard processor, an onboard output device, and other supplementary devices. As used herein, the term “on board” refers to being installed or carried on automobiles, aircrafts, ships, or other types transportations.

Depending upon the type of means of transportation on which it is installed, the onboard processor can be implemented with one or more application-specific integrated circuits (ASIC), digital signal processors (DSP), digital signal processing devices (DSPD), programmable logic devices (PLD), field-programmable gate arrays (FPGA), central processing unit (CPU), controllers, micro-controllers, microprocessors, or other electronic components and be used to execute the virtual fence-based information-processing method described above. The onboard processor is connected and coupled, either through wiring within the car or wirelessly, to the onboard input device and onboard output device.

Depending on the type of the means of transportation on which it is installed, the onboard output device could be an interface (such as a voice playback device, an amplifier, or earphones) capable of interacting with users, or a transceiver that establishes a wireless transmission with a user's hand-held device. The onboard output device may be coupled, either through in-car wiring or wirelessly, to the onboard input device and onboard processor.

Depending on the type of the means of transportation on which it is installed, the onboard input device may comprise multiple input devices. For example, it can comprise at least one of the following: a user-oriented automotive user interface, a device-oriented automotive device interface, and a transceiver. Optionally, the device-oriented device interface may be a wired interface for conducting device-to-device data transmissions (e.g., an interface for connecting to a dashboard cam recorder, a dashboard-to-car door cable interface, a dashboard-to-A/C hardware interface), or it could be a hardware insertion interface (e.g., a USB interface or a serial port) for conducting device-to-device data transmissions. It can also be an interface between such automotive hardware as seat belt insertion slots or the engine and other control devices. Alternatively, the user-oriented automotive user interface could, for example, be steering wheel control keys for a car, control keys for centralized control of a large or small vehicle, a voice input device for receiving voice input (such as a microphone mounted on a steering wheel or rudder, central sound capture equipment, etc.), or a user touchscreen perceiving device for receiving user touch input (such as touchscreen or a touch tablet having touch-sensing functions). Alternatively, the transceiver described above can be a transceiver antenna, a baseband chip, or a radio-frequency transceiver chip with communication capabilities in a car.

FIG. 6 illustrates a functional diagram of an in-vehicle system for virtual fencing, in accordance with an embodiment of the present disclosure. In-vehicle system 600 can be implemented by, for example, computing system 400 of FIG. 4 or computing system 500 of FIG. 5. In-vehicle system 600 can be a sub-system of a vehicle, in communication and interaction with other modules or sub-systems of the vehicle. In-vehicle system 600 can also be a standalone system of a vehicle. In-vehicle system 600 can be configured to communicate with servers on various networks as well as with other in-vehicle systems, as part of providing services such as voice communication, messaging, positioning, navigation, mobile Internet access, emergency rescue, vehicle data and management, and in-vehicle entertainment, and the like. In-vehicle system 600 can be used to implement processes of FIGS. 1 and 2.

As shown herein, in-vehicle system 600 includes a fence-generating unit 31 and a forwarding unit 32. Fence-generating unit 31 is configured to generate a virtual fence based on a triggering condition obtained via an input of in-vehicle system 600. The triggering condition comprises point-of-interest information and/or area-of-interest information.

Forwarding unit 32 is configured to generate a notification and forward the notification to a client after it is determined that the user status information obtained at in-vehicle system 600 meets the triggering condition of the virtual fence.

Alternatively, forwarding unit 32 is configured to generate a notification and forward the notification to a server after it is determined that the user status information obtained at in-vehicle system 600 meets the triggering condition of the virtual fence.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for processing information, comprising:
obtaining first user status information pertaining to user location, user behavior, or both;
generating a first notification upon detecting that the first user status information meets a triggering condition of a virtual fence, wherein the triggering condition comprises point of to interest information, area of interest information, or both; and
sending the first notification.

2. The method of claim 1, wherein the virtual fence comprises at least one of:
a point-of-interest fence;
an area-of-interest fence;
is a road fence designated according to categories of the roads or names of the roads;
a route fence of specified series of routes; and
an event fence designated with specific triggering information.

3. The method of claim 1, further comprising:
receiving a second notification transmitted by a client device, wherein the second notification is generated after the virtual fence is generated for the client device based on the triggering condition, after a second user status information is obtained and determined as meeting the triggering condition.

4. The method of claim 3, wherein the triggering condition corresponds to a designated operation, further comprising:
transmitting the first notification or the second notification to a third-party server, wherein the third-party server executes the designated operation based on the first notification or the second notification.

5. The method of claim 1, further comprising:
receiving fence configuration information input by a user through a third-party server, wherein the fence configuration information comprises the trigger condition; and
generating the virtual fence based on the fence configuration information.

6. The method of claim 5, wherein the fence configuration information further comprises a validation condition, the method further comprising:
determining that the first user status information does not meet the triggering condition,
determining that the virtual fence meets the validation condition; and
in response to determining that the virtual fence meets the validation condition, returning to the obtaining of the first user status information.

7. The method of claim 5, wherein the fence configuration information further comprises a to validation condition, the method further comprising:
determining that the first user status information does not meet the trigger condition,
determining that the virtual fence does not meet the validation condition; and
in response to determining that the virtual fence does not meet the validation condition, deleting the virtual fence.

8. The method of claim 1, wherein the triggering condition further comprises designated user behavior information; the first user status information comprises first location data and/or first behavior data;
determining of whether the first user status information meets the triggering condition of the virtual fence comprises:
determining, if the first location data is located at the point of interest information or point of area information and/or the first behavior data matches the designated user behavior information, that the first user status information meets the triggering condition; and
determining, if the first location data is not located at the point of interest information or point of area information and/or the first behavior data does not match the designated user behavior information, that the first user status information does not meet the triggering condition.

9. A method of claim 1, wherein the first notification is sent to a server.

10. The method of claim 9, wherein the virtual fence comprises at least one of:
a point-of-interest fence;
an area-of-interest fence;
a road fence designated according to categories of the roads or names of the roads;
a route fence of specified series of routes; and
an event fence designated with specific triggering information.

11. The method of claim 9, further comprising:
receiving a third notification transmitted by the server, wherein the third notification is generated after the server has generated a virtual fence based on the triggering condition, has collected third user status information, and determined that the third user status information meets said the triggering condition.

12. The method of claim 11, wherein the triggering condition corresponds to a designated operation, further comprising:
to transmitting the first notification or the third notification to a third-party server, wherein the third-party server executes the designated operation based on the first notification or the third notification.

13. The method of claim 9, further comprising:
receiving fence configuration information sent by the server, wherein the fence configuration information is input by a user through a third-party server; and
generating a virtual fence based on the fence configuration information.

14. The method of claim 9, wherein the generating of the virtual fence comprises:
receiving fence configuration information input by a user through a third-party application, wherein the fence configuration information comprises the triggering condition; and
generating a virtual fence based on the fence configuration information.

15. The method of claim 13, wherein the fence configuration information further comprises a validity condition; the method further comprising:
determining that the first user status information does not meet the triggering condition;
determining that the virtual fence meets the validation condition; and
in response to determining that the virtual fence meets the validation condition, returning to the obtaining of the first user status information.

16. The method of claim 13, wherein the fence configuration information further comprises a validation condition, the method further comprising:
determining that the first user status information does not meet the trigger condition, determining that the virtual fence does not meet the validation condition; and
in response to determining that the virtual fence does not meet the validation condition, deleting the virtual fence.

17. The method of claim 9, wherein the triggering condition further comprises designated user behavior information; the first user status information comprises first location data and/or first behavior data; determining of whether the first user status information meets the triggering condition of the virtual fence comprises:
determining, if the first location data is located at the point of interest information or point of area information and/or the first behavior data matches the designated user behavior to information, that the first user status information meets the triggering condition; and
determining, if the first location data is not located at the point of interest information or point of area information and/or the first behavior data does not match the designated user behavior information, determining that the first user status information does not meet the triggering condition.

18. A virtual fence device, comprising:
one or more processors configured to:
obtaining first user status information pertaining to user location, user behavior, or both;
generating a first notification upon detecting that the first user status information meets a triggering condition of a virtual fence, wherein the triggering condition comprises point of interest information, area of interest information, or both; and
sending the first notification; and
one or more memories coupled to the one or more processors and configured to provide the one or more processors with instructions.

19. A computer program product for virtual fencing, the computer program product being embodied in a tangible non-transitory computer readable storage medium and comprising computer instructions for:
obtaining first user status information pertaining to user location, user behavior, or both;
generating a first notification upon detecting that the first user status information meets a triggering condition of a virtual fence, wherein the triggering condition comprises point of interest information, area of interest information, or both; and
sending the first notification.
